(19) United States
(12) Patent Application Publication
(10) Pub. No.: US 2021/0384562 A1
(43) Pub. Date: Dec. 9, 2021

(54) PROCESS FOR PHYSICALLY SEPARATING AND RECOVERING VARIOUS COMPONENTS FROM SPENT LITHIUM ION BATTERIES

(71) Applicant: XProEM Ltd., Oakville (CA)

(72) Inventors: Xintong LIU, Oakville (CA); Chattopadhyay KINNOR, Toronto (CA)

(21) Appl. No.: 17/230,943

(22) Filed: Apr. 14, 2021

Related U.S. Application Data
(60) Provisional application No. 63/035,051, filed on Jun. 5, 2020.

(51) Int. Cl. H01M 10/54; H01M 10/0525; C22B 26/12; H01M 4/58

(52) U.S. Cl. CPC H01M 10/54; H01M 4/5805; C22B 26/12; H01M 10/0525

(57) ABSTRACT

The present invention is a process of physical separation of spent lithium ion batteries to recover valuable components by using vacuum treatment to separate and recover volatile matter such as electrode binder, electrolyte solvent and salt followed by crushing and comminution to disintegrate and shred the electrolyte-depleted battery pack and reduce the size of shredded particles of enclosed components such as casing, current collectors, separator and other materials, which are subsequently separated using a series of physical separation techniques.

### FIELD OF THE INVENTION

The present application relates a method for physically separating and recovering valuable components from spent lithium ion batteries (“LIB”), such as electrodes, casing, electrolyte and collectors, using vacuum extraction technology and various physical separation techniques. Certain recycled materials are recovered in high purity and can be directly sent for reuse, while others require further processing to regain proper physical form or chemical structure for commercial applications.

### BACKGROUND OF THE INVENTION

Lithium ion batteries are one of the most widely used battery types, which traditionally gained importance in the consumer electronics industry. Over the last 5 years, there has been a strong increase in numbers globally in electric vehicles (“EVs”) powered by lithium ion batteries. According to the lEA's Global EV Outlook (2019), the number of EVs on roads globally is expected to exceed 145 million vehicles on the road by 2030, with China contributing to over 50% of new EVs manufactured.

With current battery technology, the usable life of LIBs for EV applications is in the range of 5-8 years, resulting in a large number of spent LIBs after the battery packs in EVs are retired. With increasing demands for longer travelling distance per charge, there have been steady improvements to the batteries (capacity, energy density). Battery life can thus be expected to improve over time. The wave of retiring batteries represents the amount of batteries requiring appropriate recycling.

The present invention develops a process to discharge and disintegrate spent lithium ion batteries for recovering essentially all major components in an environmentally friendly fashion. The separated and recovered materials include cathode and anode in dry powders, collector foils in shredded aluminum and copper particles, plastic casing and separator membrane in debris, steel casing in shredded pieces, electrolyte solvent in condensate, and electrolyte salt and electrode binder in either original form or decomposed components.

Current state of art of physical separation for recycling the spent lithium ion batteries involves submerging the discharged spent LIBs in alkaline solution to neutralize toxic hydrogen fluoride (“HF”) and other corrosive substances generated from such practice. There are certain drawbacks associated with such procedures: first of all, it consumes and contaminates a significant amount of water; secondly it requires strong alkaline substances such as sodium hydroxide or calcium hydroxide for treating toxic and corrosive effluent; lastly, many existing physical separation operations combust or oxidize valuable anode material, electrode binder and electrolyte solvent along the process for heat generation or impurity removal.

The present invention employs all unit operations in a water free environment after discharging and captures all volatile hazardous material using a vacuum extraction technology to avoid pollution to the environment or cross contamination with other recycled substances. In addition, the present invention is designed to recover all enclosed materials in a typical spent LIB pack. For instance, the present invention delicately deals with the graphite recovered from anode and collects it for direct reuse or further restoration, which reduces unnecessary greenhouse gas emissions and improves the recycling economics at the same time. The cascade design for heating treatment in the present invention also enables the preservation of volatile matters such as electrolyte solvents in their pristine form for direct recycling and reuse.

### SUMMARY OF THE INVENTION

The present invention outlines a method for physically disintegrating spent lithium ion batteries and recovering essentially all valuable materials in reasonably high purity. Vacuum extraction and distillation are applied to separate and recover volatile matter such as electrode binder, electrolyte solvent and salt. Crushing and comminution are subsequently applied to disintegrate and shred the electrolyte solvent from the depleted battery pack, and reduce the size of shredded particles of enclosed components such as the casing, current collectors, separator and other materials, for subsequent separation and recovery. The electrode materials, namely lithium bearing metal oxides and graphite, are recovered in their native powder state through a series of physical separation techniques including sieving and gravity separation. Carbon dioxide (“CO₂”) is applied as an inert gas to avoid fires from LIB pack discharging and to facilitate vacuum extraction as a heat source and sealing gas.

The spent lithium ion battery pack is firstly discharged in a saline solution to release any residual electrical powder. The fully discharged LIB pack is then opened to allow electrolyte to be drained by gravity. After sufficient draining takes place, the drained LIB pack is heated to a temperature 50° C. to 80° C., to drive out any residual electrolyte solvent trapped inside the electrode or membrane separator, in an enclosed chamber with partial vacuum conditions and an inert CO₂ atmosphere. Differential heat treatments and vacuum strength can be applied depending on whether HF is present in the system, as indication of reactions involving phosphorus pentafluoride (“PF₅”) and water or organic solvents having taken place. After HF and other co-products from PF₅ reaction are thoroughly removed, the vacuum chamber can resume its regular configuration and continue to evaporate the electrolyte solvent, which is recovered via condensation afterwards.

Once the electrolyte solvents and other volatile substances are extracted out of the LIB pack, the LIB pack is crushed using a commercial crusher to disintegrate the components into smaller pieces. To fully liberate some of the materials from each other and reduce the overall sizing of the mass flow, crushed LIB pack pieces are shredded using additional pulverizing equipment. The shredded particles are then sent for dry magnetic separation where majority of magnetic active steel casing debris is removed and the rest of the materials are applied through sieving where finer powders, mostly liberated cathode and anode, are separated from coarser shredded particles.

The coarser particles are subsequently sent through dry gravity separation to remove lighter debris of plastic, aluminum-plastic, and membrane from heavier metallic particles. To further liberate the cathode powders, which are tightly glued to the metallic collector, the heavier metallic particles are heated to an intermediate temperature to remove the organic binder material through evaporation and decomposition. For the electrolyte salt, lithium hexafluorophosphate (“LiPF₆”) carried over with electrode powder, it will also undergo thermal decomposition under heating and dissociate into volatile PF₅ and lithium fluoride (“LiF”) powder, and PF₅ will exit the system in the vapor phase along with effluent from the decomposition of the binder material.

After the extraction of the fluoride-bearing vapor, the remaining coarser material is sent to undergo another pass of sieving to separate finer electrode powders recently liberated from the shredded metallic foils. The oversized shredded metallic pieces are then applied through another pass of gravity separation to separate heavier copper foils from the lighter aluminum foils. The finer powders need to undergo high intensity magnetic separation to remove any remaining iron-bearing particles and debris. Subsequently the non-magnetic powder is heated up to 150-200° C. to fully decompose any remaining LiPF₆ and evaporate away PF₅ generated. The LiF generated concurrently with PF₅ will join the LiF already present in the powder.

The last step is to separate LiF from the cathode and anode powder. For the less thermally stable cathode active material such as lithium nickel cobalt manganese oxide or lithium nickel cobalt aluminum oxide, calcination under the presence of graphite at an intermediate temperature is applied to convert the cathode into a preferred transition metal oxide state, in order to increase the overall density of the cathode powder. Subsequent steps involve gravity separation of the denser cathode from the much lighter LiF and graphite. For more thermally stable cathode active material such as lithium iron phosphate, vacuum extraction can be applied to remove relatively volatile LiF from the mixture and the fluoride-free powder can be sent for the last step of gravity separation to isolate graphite from the denser cathode material of lithium iron phosphate.

In the case where HF is generated due to excessive moisture present, stronger suction is applied to enhance the vacuum to expedite the removal of HF and other halogenorganic compounds which may form along with HF.

### BRIEF DESCRIPTION OF THE DRAWINGS

For a better understanding of the present application, as well as other aspects, embodiments, and further features thereof, reference is made to the following description which is to be used in conjunction with the accompanying figures and/or tables, where:

FIG. 1 shows a block flow diagram of an embodiment of the depicted process configured for LIB with thermally stable cathode material.

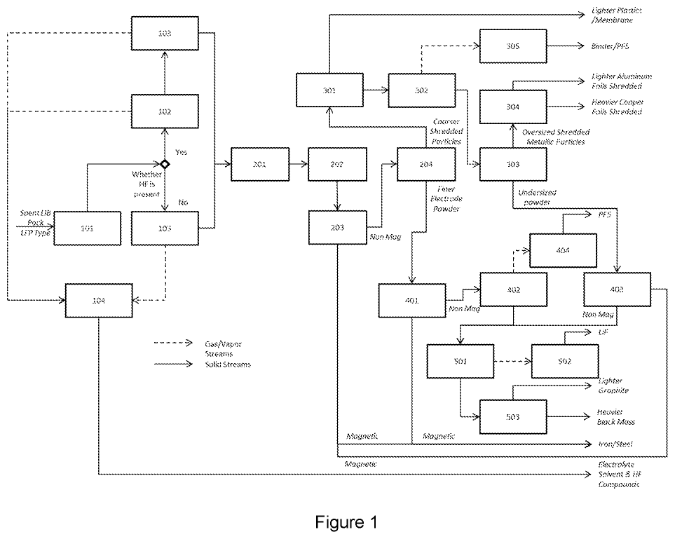

FIG. 2 shows a block flow diagram of an embodiment of the depicted process configured for LIB with thermally unstable cathode material.

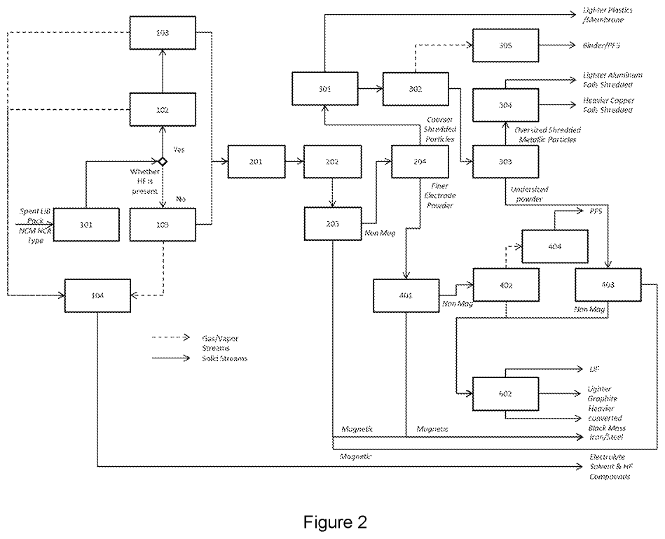

FIG. 3 shows Table 1, which summarizes the composition of a typical EV LIB pack with cathode material of lithium iron phosphate by component, which the present invention can process effectively.

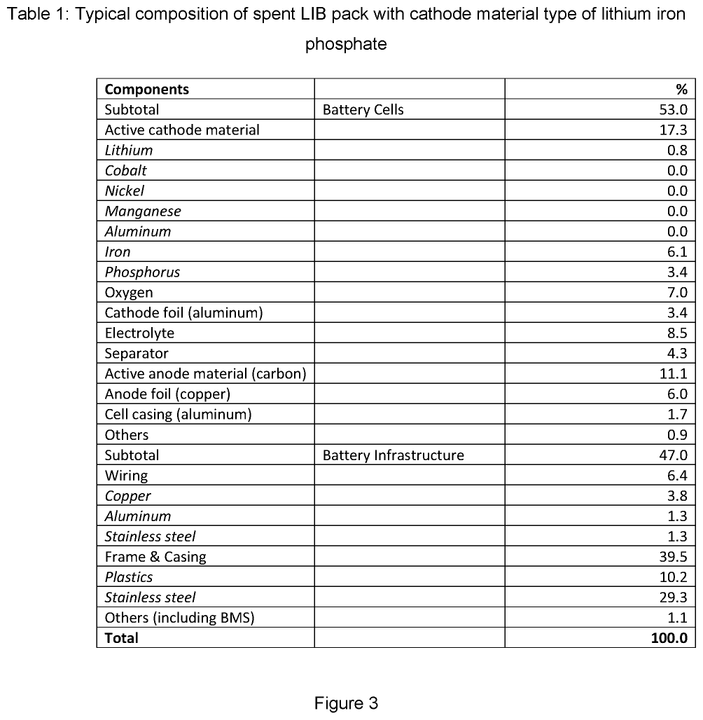

FIG. 4 shows Table 2, which summarizes the composition of a typical EV LIB pack with cathode material of lithium nickel cobalt manganese oxide by component, which the present invention can process effectively.

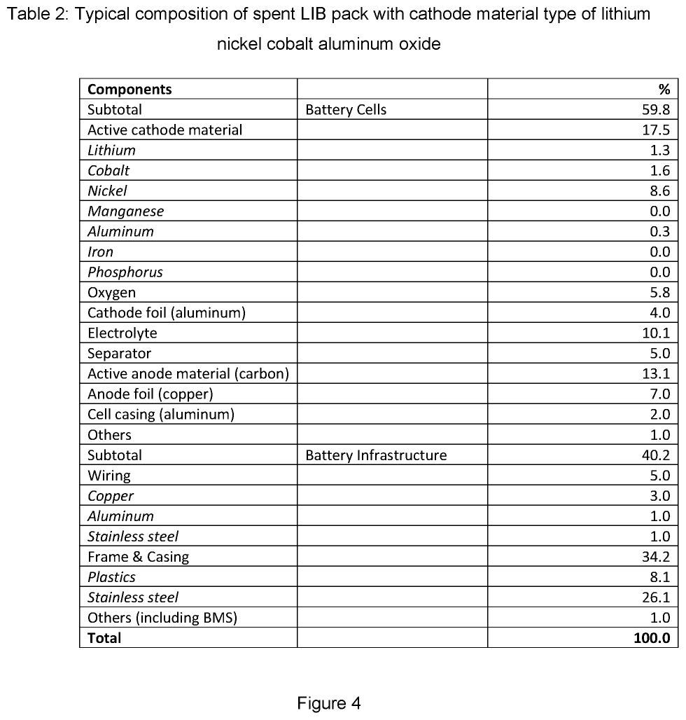

FIG. 5 shows Table 3, which summarizes the composition of a typical EV LIB pack with cathode material of lithium nickel cobalt aluminum oxide by component, which the present invention can process effectively.

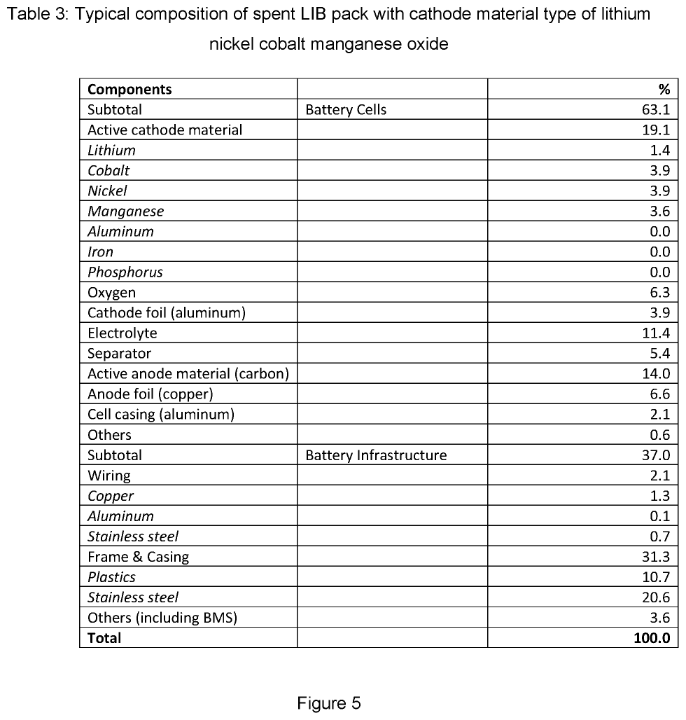

### DETAILED DESCRIPTION OF THE INVENTION

The present invention relates to a method of recovering essentially all enclosed components in either original form or via decomposition into smaller and more volatile compounds. Vacuum extraction technology is extensively applied in the present invention to facilitate the evaporation of targeted substances, such as electrolyte solvents, electrode binder and electrolyte salt. In addition, various physical separation techniques are utilized in the present invention to extract the desired products.

Although example embodiments of the disclosed technology are explained in detail herein, it is to be understood that other embodiments are contemplated. Accordingly, it is not intended that the disclosed technology be limited in its scope to the details of construction and arrangement of components set forth in the following description or illustrated in the drawings. The disclosed technology is capable of other embodiments and of being practiced or carried out in various ways.

Throughout this specification, unless specifically stated otherwise or the context requires otherwise, reference to a single step, composition of matter, group of steps or groups of compositions of matter shall be taken to encompass one and a plurality of those steps, compositions of matter, groups of steps or groups of composition of matter. Thus, as used herein, the singular forms “a”, “an” and “the” include plural aspects unless the context clearly dictates otherwise. Range may be expressed herein as from “about” or “approximately” one particular value and/or to “about” or “approximately” another particular value. When such a range is expressed, other example embodiments include from the one particular value and/or to the other particular value. Furthermore, unless the context clearly requires otherwise, throughout the description and the claims, the words “comprise”, “comprising”, and the like are to be construed in an inclusive sense as opposed to an exclusive or exhaustive sense; that is to say, in the sense of “including but not limited to”.

Unless otherwise defined, all technical and scientific terms used herein have the same meaning as commonly understood by one of ordinary skill in the art to which this invention belongs. Although methods and materials similar or equivalent to those describe herein can be used in the practice or testing of the present invention, suitable methods and materials are described below. In case of conflict, the present specification, including definition, will control. In addition, the materials, methods, and examples are illustrative inly and not intended to be limiting.

Furthermore, each example of the present disclosure described herein is to be applied mutatis mutandis to each and every other example unless specifically stated otherwise. The present disclosure is not to be limited in scope by specific examples described herein, which are intended for the purpose of exemplification only. Functionally equivalent products, compositions and methods are clearly within the scope of the disclosure as described herein.

The term “and/or”, e.g., “X and/or Y” shall be understood to mean either “X and Y” or “X or Y” and shall be taken to provide explicit support for both meanings or for either meaning.

As defined herein, the “LIB pack” corresponds to the collection of numerous battery cells stacked, fixed, and enclosed in a steel and plastic casing. Typical compositions of EV LIB components by weight are summarized in Table 1, 2 and 3.

Spent LIB packs are collected and stored from various applications after the end of life at first. The collected spent LIB packs may not be fully discharged so there is a strong potential of fire hazard if the spent battery is short circuited or stored improperly. Onsite discharging is recommended to minimize the chance of any thermal events which may lead to a disastrous thermal runaway accident. A thermal runaway accident is categorized by a series of autogenous exothermic reactions involving oxygen and highly reactive compounds released from decomposition of thermally unstable substances contained inside of a spent LIB pack, such as electrolyte solvents. The thermal runaway can quickly increase the battery temperature to as high as 700° C., which will cause more material to combust or decompose to further fuel the thermal event. Therefore to mitigate the risk of thermal runaway, several measures are taken in the present invention. Firstly, the time to store a spent LIB pack should be minimized and a good heat removal mechanism, such as forced air ventilation cooling system, should be in place at the storage site. Secondly, proper discharging should be carried out to reduce the risk of short circuiting, which will generate a significant amount of heat. Thirdly, the storage and discharging should take place in the absence of external oxygen, so adequate air sealing is also required to create a safe oxygen-depleted atmosphere.

As alluded to earlier, discharging can effectively reduce the potential health and safety hazards such as fire or explosion. In certain embodiments, discharging of individual spent LIB packs can be done by submerging in a saline solution of 1%-5% solute concentration. The salt used in the saline solution can be sodium chloride, potassium chloride, sodium nitrate or any other equivalent highly soluble conductive salt. The initial conductivity level of the saline solution should be greater than 40 mS/cm to facilitate competent discharging operation.

As extremely acidic or basic solution can be detrimental to the safety, the pH value of the saline solution should be within 5-10 to avoid any significant corrosion to the steel casing, which may compromise its integrity and increase the chance of electrolyte leakage.

In one preferred embodiment, the duration of immersion in the saline solution should be 10-24 hours, to adequately lower the remaining voltage while not causing damage to the casing. It will be appreciated by those skilled in the art that, other things being equal, the more conductive the saline solution is, the shorter the time it takes to completely discharge the spent LIB pack.

After the spent LIB pack is fully discharged and completely dried in an oxygen-free atmosphere, it is sent to a vacuum chamber at step 101 to undergo gravity draining remove the electrolyte solvent. The chamber is closed and CO₂-sealed the entire time to ensure absolute airtightness. Before the draining is started, the outer casing is loosened or removed entirely, and small holes are made to the battery cell pouches, or any other electrolyte containing units, to allow electrolyte to exit the spent LIB pack by gravity.

In certain embodiments, a collection pan or sink is placed underneath the belt conveyer where the spent LIB pack is situated. The draining time should be 2-5 hours to permit majority of the contained electrolyte to exit the spent LIB pack from the bottom. In a preferred embodiment, 50-80% of the electrolyte can be drained and collected within 6 hours of operation. The remaining electrolyte is intimately captured within the cathode, anode or separator and requires additional treatment for extraction.

Once the gravity draining is finished and the drained electrolyte is removed for further recovery, the chamber starts to adopt a partial vacuum condition with moderate temperature rise at step 103. Most of the organic carbonates used in making up the electrolyte solvent, such as dimethyl carbonate (DMC) or ethyl methyl carbonate (EMC), have a boiling point around 100° C. under atmospheric pressure. With partial vacuum under 1 kPa and temperature up to 80° C., the prescribed conditions are sufficient to not only evaporate DMC and EMC, but also to readily extract the less volatile solvents such as ethylene carbonate and propylene carbonate via the vapor phase. In a preferred embodiment, any remaining electrolyte solvents can be thoroughly evaporated by applying the combined vacuum and heating as described above within 60-240 minutes.

It is critical that the moisture level in the vacuum chamber is maintained at a very low level, to avoid undesired hydrolysis of LiPF₆, either directly or via the highly reactive PF₅, a product from LiPF₆'s decomposition, which generates the corrosive HF. PF₅ is a strong Lewis acid and can undergo a cascade of reactions with water and a number of organic compounds present, to continue producing HF and other fluoride-bearing compounds. Therefore it is ideal to control the ambient moisture level as well as the moisture level within the spent LIB pack. CO₂ sealing can effectively lower the moisture content in the atmosphere as water vapor carried in the incoming CO₂ gas has been properly removed using a desiccant. In one preferred embodiment, the moisture level around the spent LIB pack should be lower than 10 ppm and by no means over 1,000 ppm.

If a significant portion of HF is detected in the offgas with the vaporized electrolyte solvents, step 102 is undertaken before step 104 so that an alternative ventilation shaft with protective inner lining is opened to allow the corrosive HF to exit the system without causing damage to the equipment. The regular ventilation system is closed until the HF level has decreased to a minimal level. Within the chamber, the strong vacuum is kept on to facilitate fast removal of HF and its ensuing halogen organic compounds. However the vacuum temperature should be lowered to 30-50° C. to lower the degree of severity of the reactions involving HF, again to preserve the configurational and compositional integrity of the spent LIB pack. Once HF has dropped to a safer level, the regular operation mode of electrolyte solvent extraction is resumed and proceeds to completion.

The HF and other corrosive compounds are extracted and routed to a scrubbing unit for fluoride removal at step 104. Alkaline substances are applied at the scrubber either via aqueous slurry spray or packed in a fixed bed configuration. In certain embodiments, calcium hydroxide suspension solution in a solid weight percent from −5% at 25° C. The resulting calcium fluoride (“CaF₂”) can be collected and purified for several commercial uses.

After the volatile electrolyte solvents and possible fluoride-bearing compounds are readily removed from the vacuum chamber, the vacuum condition can stop and the belt conveyer will subsequently carry the “dried” LIB pack to step 201 for crushing and dismantling. If the outer casing is removed while the draining is performed, it is also sent to the crusher for disintegration and size reduction. For the purpose of this disclosure, the crushing unit can comprise of a shear crusher, jaw crusher, gyratory crusher, or combination of them. In the event that multiple crushers are used in the crushing step, it is desirable to have the feedstock processed by the shear crusher first before a jaw crusher or gyratory crusher as the shear crusher is more efficient in reducing the size of coarser particles. The LIB pack is crushed to less than 20 mm at 90% passing rate and the crushing time can last from 30-120 minutes depending on the feed size, target product particle size and type(s) of crusher used.

Crushed LIB pack pieces are then processed through a shredding step 202 to further reduce the particle size to enable subsequent physical separation procedures. For the purpose of this disclosure, the crushing unit can comprise of an impact crusher, cone crusher, hammer mill, impact mill, or combination of them. The target size at 90% passing for the shredded material will be 10-20 mesh to liberate some of the electrode powder adhered to the current collector metal foils. The processing time for shredding stage can be from 30-120 minutes, depending on the feed size, target product particle size and type(s) of crusher or mill used.

It will be appreciated by those skilled in the art that, other things being equal, the coarser the feed material and the finer the product sizing requirement, the longer it takes for the crushing and shredding to take place, and the more energy such a process step will consume.

Once particle sizing of the shredded LIB pack is reduced to the desired level, the entire mass, including shredded pieces of casing and foils as well as fine electrode powders having fallen off the current collector, is sent to a dry magnetic separation step 203. The target material to separate at this stage is mostly magnetic steel casing debris which is highly magnetically active. Therefore, a low intensity magnetic separator (“LIM”) is applied to avoid any inadvertent pick up of cathode powder, which consists of transition metals such as Co, Ni or Mn. In a spent LIB pack, it is likely that due to the repeated charging and discharging cycles, certain cathode active material has decayed into transition metal oxides such as Co₃O₄, CoO, Ni₃O₄, NiO, Mn₃O₄ and MnO, which can be weakly magnetic susceptible and magnetized in a strong magnetic field. In certain embodiments, the magnetic intensity of the LIM should be in a range of 50-250 mT and less than 500 mT. The collected steel debris can be sold to a steel scrap yard or directly to an electric arc furnace operator for making new steel products.

The mixture material is then sent to a sieving step 204 to recover electrode powder already liberated from the current collector. The sieve size is set to 600 mesh to screen off at least 99.9% of coarser shredded particles from the casing, membrane, and metal foils, while allowing 100% of finer electrode powder through for collection.

The coarser shredded particles are thereafter run against a gravity separation step 205 to remove the low melting point plastic materials and separator membrane carried over. Due to the large density gap between lighter plastic and membrane used in LIB pack (0.9-1.0 g/cm³ for plastic and 0.90-0.97 g/cm3 for typical membrane materials such as polyethylene and polypropylene) and heavier metallic components present (2.7 g/cm³ for Al and 8.8 g/cm³ for Cu), gravity separation based on these density differences can be effectively exploited to isolate majority of the plastics from the mixture. Although the plastic and membrane materials used in the LIB pack are already featured with thermal stability and heat resistance, their melting points are often in the range of 100-200° C. Because more heat treatments at higher temperatures are to be applied in subsequent steps, it is critical to make sure there is as little as plastic or membrane remaining after this step so that the following heat treatments can be run without interference from molten polymeric material or plastic, which can cause severe operational issues as well as environmental hazards. For the purpose of this disclosure, the gravity separation unit can comprise of an air classifier, cyclone, dry shaking table, or combination of them. The collected plastic and membrane materials can be sold to different recycling facilities for recycle or reuse, based on their respective chemical makeup or functional properties.

As alluded to earlier, after the plastic and membrane are taken out from the mixture, the coarser shredded particles are then treated for an additional heating step 302 in an enclosed furnace to increase the temperature to 100-200° C. to facilitate the decomposition of remaining LiPF₆ still contained. As mentioned previously, LiPF₆ readily decomposes at temperature range beyond 100° C. into PF₅ and LiF, while PF₅ is of a volatile nature and can be removed via evaporation. It should be also noted that heating treatment should be controlled so that the temperature does not rise over 200° C. when LiPF₆ has a strong tendency to melt which in turn hinders its own removal. For the purpose of this disclosure, the thermal treatment unit can comprise of a shaft furnace, rotary calcining furnace or other types of commercially available industrial heating equipment.

After PF₅ is thoroughly removed, thermal treatment is continued to be applied to raise the temperature to over 400° C., in order to decompose the polymeric binder materials such as polyvinylidene fluoride (PVDF), which is used to increase the adhesion between the aluminum foil and the cathode active materials. Graphite is preserved through the heating despite the presence of large quantities of CO₂ due to the unfavorable reaction thermodynamics at this low reaction temperature. The heating time should be in a range of 30-120 minutes and the temperature range for the thermal treatment should be 400-500° C., depending on the amount of LiPF₆ and binder present in the mixture. The evaporated PF₅ and decomposed PVDF are individually recovered in the downstream distillation step 305 for separation and further treatment.

The solid particles left from thermal treatment are sieved again at step 303 to collect electrode powders recently liberated from previous heating and calcination. The sieve size is again set to 600 mesh, same as that of the sieving step applied earlier as there has not been any further sizing reduction since. In a preferred embodiment, over 99.9% of oversized particles are retained by the sieve and nearly all undersized electrode powders pass through the sieve for collection and subsequent processing.

The last step 304 to fully separate the coarser stream is another gravity separation unit, through which lighter aluminum foil and heavier copper foil are separated from each other. Again, the large density difference between aluminum and copper is conducive to the performance of gravity separation. For the purpose of this disclosure, the gravity separation unit can comprise of an air classifier, cyclone, dry shaking table, or combination of them. Several passes can be applied to improve the degree of separation and reduce the impurity level in each segregated streams. For batch or semi-continuous operation, this step can be achieved using the same sieving unit described in [0042]. However if the unit is operated continuously, a second sieving unit needs to be put in place to ensure steady mass flow through the process. The separated copper and aluminum foils in shredded particle form can be sold to metal scrap yards or directly to copper smelters and aluminum manufacturers as feedstock materials.

High intensity magnetic separation (“HIM”) is applied at step 401 and 403 to further remove any magnetically active material potentially entrained in the fine mixture collected from both sieving steps 204 and 303 at which coarser particles are screened away from the undersized electrode powders. In certain embodiments, the magnetic intensity of the HIM should be in a range of 250-1000 mT. The magnetically active materials removed from these two steps, mostly steel debris, are combined with the magnetic head stream obtained from step 203 and can be sent to a steel scrap yard or directly to an electric arc furnace operator for making new steel products.

The non-magnetic stream obtained from the HIM in step 401 is essentially the electrode powders liberated without thermal treatment to dissociate away from the current collectors, and hence still contains a certain amount of LiPF₆ and binder materials. Heating procedures applied in step 402 are also applied to the non-magnetic stream to decompose LiPF₆ into PF₅ and LiF, evaporate away PF₅ and decompose the binder material for removal. One can refer to [0043] to [0044] for the heating conditions and configuration. Notwithstanding, it can be reasonably expected that the holding time once the temperature reaches the target range can be shorter as the mass flowrate for this step is smaller than step 302, which contains essentially all the shredded metallic foils. PF₅ and decomposed binder materials are also collected in a similar manner as outlined in [0044].

LiF powder produced from LiPF₆ decomposition has a much higher boiling point and cannot be easily evaporated away from the remaining cathode and anode powders. Therefore additional procedures are required to exploit the differences between the physical properties of each powder material mixed from step 402 and 403.

For the types of more active cathode materials which are thermally less stable such as lithium nickel cobalt manganese oxide, they tend to convert into transition metal oxides, such as nickel oxides, cobalt oxide, and manganese oxide, and release oxygen upon heating at elevated temperature and under non-oxidizing conditions. Compared to LiF, transition metal oxides have a much higher density range (5.0-7.0 g/cm³), which allows the subsequent step to exploit the density gap between them and LiF. The roasting step 402 is carried out in a temperature range of 300-450° C. and should be held for 60-180 minutes at the target temperature to complete the “in-situ” conversion of the transition metal oxides into their denser and more stable forms, such as CoO or Co₃O₄ for cobalt and NiO or Ni₃O₄ for nickel. Similarly, the heating unit is filled with CO₂ as a protective gas to prevent undesired reactions.

It is highly advisable that the temperature does not exceed 500° C. and the holding time does not go beyond 240 minutes to avoid excessive decomposition or carbothermic reduction which may disintegrate the oxide lattice and lower the density of the now heterogenized cathode powder. It should be noted that the heat treatment applied during step 302 to decompose the binder material can also cause such conversion to happen once the temperature is in the “conversion zone”, therefore the time of heat treatment after the temperature reaches its target should be counted into the total amount of time during which the cathode powder is under roasting.

In a preferred embodiment, a considerable portion, as high as 50%, of cathode powder has been heat-treated and converted into denser heterogenized oxides during step 302 and the time and energy consumption to process the remaining amount of cathode powder can be significantly reduced at step 402.

The conversion of active cathode material into stable oxides is also more favorable for its subsequent chemical separation process to separate individual metallic elements contained. For a hydrometallurgical process route, stable metal oxides with lower valence state of the metal element is preferred over untreated active cathode material of high reactivity for better reaction control. Similarly, for pyrometallurgical processing, releasing of oxygen from the active cathode material is also favored since less reductant will be required to reduce the metal elements back to their metallic state.

Once the roasting is completed and the density of active cathode material has increased readily, the mixture can be cooled down and sent through another pass of gravity separation to isolate graphite, LiF and active cathode material. As explained earlier, a favorable gravity separation opportunity exists when there are large density gaps between each of the constituents to be separated, namely lighter graphite (<1.0 g/cm³), intermediate LiF (2.64 g/cm³) and heavier converted active cathode material (>4.5 g/cm³). For the purpose of this disclosure, the gravity separation unit can comprise an air classifier, cyclone, dry shaking table, or combination of them. The collected and purified LiF can be used for manufacturing the electrolyte salt LiPF₆ again. It is highly desirable to process spent graphite from the anode and converted oxide powders from the cathode back to usable forms and recycle them back to the LIB manufacturing supply chain. Therefore further chemical treatment, either pyrometallurgical or hydrometallurgical, is required to further separate and purify the valuable components from these two mass streams.

For the types of less active cathode materials which are thermally more stable such as lithium iron phosphate, they show thermal and chemical resistance at much high temperature, which enables the application of vacuum extraction technology herein. Such practices also require heating the mixture to medium to high temperature (>500° C.), and therefore are otherwise inapplicable for more reactive cathode materials.

LiF, among many other light metal fluorides, can be readily extracted under strong vacuum and high temperature conditions at step 501. Compared to LiF, the thermally stable cathode materials and graphite have almost negligible vapor pressure even at elevated temperatures. The vacuum is applied at an absolute pressure range of 100-500 Pa and the temperature range for inside of vacuum chamber should be 650-850° C. The holding time under such conditions can be from 400-1,000 minutes, depending on the amount of LiF requiring extraction. The extracted LiF vapor can be recovered in a condensation step 502 after it exits the ventilation system and can be recycled back to its respective market.

Once LiF is thoroughly removed from the electrode powders, the mixture is allowed to cool down for the last step 503 of gravity separation. For the underlying principle and practical specifics, one can refer to [0054] for more details. In a preferred embodiment, the lighter graphite and heavier cathode material can be separated based on their density difference using a customized gravity separation unit specifically targeting the densities of each constituent, which are graphite and lithium iron phosphate.

In certain embodiments, the last step 503 and 601 can be skipped in the event the subsequent chemical processing requires both anode and cathode materials for further recycling or restoration.

The present invention being thus described; it will be obvious that the same may be varied in many ways. Such variations are not be regarded as a departure from the spirit and scope of the present invention, and all such modifications as would be obvious to one skilled in the art are intended to be included within the scope of the following claims. For instance, despite that the present invention with feed compositions specified in the tables is designed to process spent LIB from retired electric vehicles, the process described herein can be readily varied by one skilled in the art to treat LIB from consumer electronics and other end applications.

1. A process for physically separating and recovering all components from a spent LIB pack, comprising:
I. heating discharged LIB pack under low temperature to evaporate electrolyte solvent and fluoride bearing compounds potentially formed from LiPF₆ hydrolysis;
II. crushing and shredding the LIB pack to break the components into small particles and fine powders;
III. low intensity magnetic separation to remove steel casing debris from the mixture of shredded particles and loose powders;
IV. sieving to separate finer electrode powders from coarser shredded particles;
V. dry gravity separation to remove lighter plastics and membrane from heavier shredded metal foils;
VI. calcination of heavier shredded metal foils to decompose LiPF₆ and electrode binder material to drive away hyperactive PF₅ and liberate electrode powder from the current collector;
VII. high intensity magnetic separation to remove any remaining magnetically active materials from the fine electrode powder mixture;
VIII. heat treatment to convert cathode material into a denser oxide form and gravity separating LiF, lighter graphite and heavier converted cathode material from each other;
IX. vacuum extraction to remove more volatile LiF from electrode powder mixture, and gravity separating the lighter graphite and heavier cathode material from each other.

2. The method according to claim 1 wherein the cathode material comprising mostly more stable lithium bearing chemicals such as lithium iron phosphate in its composition.

3. The method according to claim 1 wherein the cathode material comprising mostly less stable lithium bearing chemicals such as lithium nickel cobalt manganese in its composition.

4. The method according to claim 1 wherein the said discharged LIB pack is drained by gravity to remove the electrolyte, followed by a dual function vacuum extraction process to alternate between removing volatile electrolyte solvent and fluoride bearing compounds as generated, respectively, under partial vacuum conditions at a temperature from 50-80° C.

5. The method according to claim 1 wherein the said LIB pack is crushed and shredded to a particle sizing distribution with a 90% cutoff at 10-20 mesh in a “coarse-fine” two-step setup.

6. The method according to claim 5 wherein the magnetic intensity of low intensity magnetic separation for said crushed and shredded LIB pack is from 50-250 mT.

7. The method according to claim 6 wherein the said non-magnetic mixture is sieved for screening off coarser particles from finer electrode powders is at 600 mesh.

8. The method according to claim 1 wherein the heating furnace is operated in two levels of temperature to selectively remove LiPF₆ and the binder material.

9. The method according to claim 8 wherein the temperature used for decomposing LiPF₆ and evaporating PF₅ is from 100-200° C., and the temperature used for decomposing electrode binder material from the said shredded metal foils to liberate finer electrode powders is from 400-500° C.

10. The method according to claim 1 wherein the magnetic intensity of high intensity magnetic separation for said fine electrode powder mixture to remove any magnetically active residuals is from 250-1,000 mT.

11. The method according to claim 7 wherein the temperature range for heating the said electrode powder to convert the cathode material into denser oxides of individual transition metals is from 350-500° C.

12. The method according to claim 7 wherein the temperature range for heating the said electrode powder to facilitate vacuum extraction of LiF is from 650-850° C. and the vacuum applied is at 100-500 Pa.

13. The method according to claim 9 wherein the graphite of anode material is preserved from oxidation via a protection gas atmosphere with CO₂ composition no less than 80-90% and temperature under 600° C.
